(19) United States
(12) Patent Application Publication
(10) Pub. No.: US 2007/0213445 A1
(43) Pub. Date: Sep. 13, 2007

(54) Stain Blocking Water Borne Coating Composition

(76) Inventors: Teunis Abram Klijn, Goedereede (NL); Derrick Twene, Goes (NL); Dirk Emiel Paula Mestach, Nijlen (BE)

Correspondence Address: HOWREY LLP, C/O IP DOCKETING DEPARTMENT, 2941 FAIRVIEW PARK DRIVE, SUITE 200, FALLS CHURCH, VA, 22042-7195, US

(21) Appl. No.: 10/586,994

(22) PCT Filed: Jan. 21, 2005
(86) PCT No.: PCT/EP05/00697

§ 371 Date: Mar. 20, 2007

Related U.S. Application Data
(60) Provisional application No. 60/543,391, filed on Feb. 11, 2004.

(30) Foreign Application Priority Data
Jan. 22, 2004 (EP) 04075135.6

(51) Int. Cl. B32B 21/04; B32B 27/20; C08K 9/04

(52) U.S. Cl. 524/445; 428/323; 428/537.1; 428/457

(57) ABSTRACT

The invention relates to a stain blocking water borne coating composition, preferably for clear coats, comprising an organic binder and as stain blocking agent at least one type of inorganic nano-particles having a layered structure and a crystal structure with positively charged layers. Further, the invention relates to a method for coating a substrate comprising water extractable staining agents wherein the substrate is coated with an organic water borne coating composition comprising as stain blocking agent at least one type of inorganic nano-particles preferably having a layered structure and a crystal structure with positively charged layers and to coated substrates obtainable by this method

The invention relates to a stain blocking water borne coating composition, a method for coating a substrate comprising water extractable staining agents, the coated substrate obtainable by said method and the use of specified inorganic nano particles as stain blocking agents in organic water borne coating compositions.

Environmental legislation is the driving force behind the change from solvent borne coatings to water borne systems. Limits have been established for the amounts of volatile organic compound that are allowed in different coating systems. The conventional solvent borne coating compositions were designed to be applied to the surfaces of certain substrates, including the surfaces of previously coated substrates. However, these substrates often contain water-soluble staining agents. So when water borne coatings are applied to such substrates, said staining agents can leach from the substrate into the coating, thus causing discolouration thereof.

Staining agents are for example the water-soluble chromophoric compounds that are present in wood, such as tannins. These tannins can leach from the substrate into the coating, causing tannin staining, which appears as discolouration on the surface of the coating. Such leaching can occur upon application or during the service life of the coating. Other staining agents that can leach from wood are terpenoid based resins or alkaloids such as chlorophorin. Yet other staining agents are salts contained In cementitious substrates. These salts can cause efflorescence or blooming, which is a staining caused by the migration of the salt from the substrate to the paint coating, where it appears as white deposits.

Staining of the substrate and of coatings previously applied to the substrate can also be caused by sources external to the substrate. For example, cigarette smoke causes nicotine staining, which discolours light coloured coatings, and inks from pens can cause marker stains on the substrate. When such stained substrates are (re)coated, this again can cause undesired discolouration of the top coat. Each of the above-mentioned effects of staining is highly undesirable in coatings.

In attempts to improve the (tannin) stain blocking of water borne coatings several approaches have been followed, which are described in the patent literature. Reactive pigments such as zinc oxide, aluminium zirconium phosphosilicate or barium phosphosilicate generally are quite effective in blocking stains caused by, for example, tannins. However, in practice they have some major drawbacks, since they can cause stability problems such as viscosity increase and polymer gelation or coagulation. Obviously, this solution is limited to pigmented coatings. However, there is also a demand for clear stain blocking coatings. It is therefore desirable to obtain the tannin blocking properties without the use of reactive pigments.

In EP 0 849 004 an attempt was made to overcome the above-mentioned disadvantages by proposing a method for the tandem coating of wood substrates. This method comprises the application of two separate coatings, one of them a highly cross-linked coating and the other a cured coating formed from an aqueous coating composition. The cured coating is formed from an aqueous composition comprising a carbonyl-functional polymer, preferably containing ethylene-ureido-containing monomers.

Other attempts to resolve this problem include modifying the polymeric composition of the binder, for example by Incorporating strong acids. US 2003/0073778 for instance describes an aqueous coating composition comprising from 0.1% to 10% by weight of at least one monomer bearing a pendant acid group having a pKa (in water at 20° C.) of less than 4, and salts thereof. However, the incorporation of strong acid groups into the binder can lead to an increased hydrophilicity of the coating, resulting in decreased water barrier properties.

In U.S. Pat. No. 4,075,394 the application of an aqueous solution of a polyalkylene imine when treating tannin-containing surfaces is disclosed. Other approaches include the use of cationic latex polymeric binders and selected cationic pigment dispersants as described in for example U.S. Pat. No. 5,312,863. The main drawback in that case is the limited availability of paint ingredients that are cationic.

In US 2003/180466 coating compositions are described comprising a nano-particle system to impart surface modifying benefits for inanimate hard surface applications. The coating composition, when applied to a hard inanimate surface of an object, reduces the formation of spots on the object, improves self-cleaning, uniform drying, cleaner appearance, etc. This document does not describe a method for the coating of substrates comprising water extractable staining agents. The coating compositions in the examples of this prior art document all comprise a nano clay having layers with an overall negative lattice charge and have relatively poor stain blocking properties.

U.S. Pat. No. 5,529,811 describes a process of inhibiting of the staining of a film-forming finish applied to a tannin containing wood substrate. The coating composition comprises as the active anti staining component a zinc cyanamide to inhibit immigration of tannin from the substrate into the coating finish. The coating composition may comprise nano particle support constituents for the zinc cyanamide, preferably zink carbonates. Other support constituents, for example clays, are reported to have no favourable effect on the stain blocking properties.

All of the above-mentioned methods suffer from various disadvantages and fail to offer an adequate solution to the problems posed. It is therefore an object of the invention to provide a water borne coating composition with an improved stain blocking properties and does not show the above-mentioned disadvantages.

According to the invention there is provided a method for coating a substrate comprising water extractable staining agents, wherein the substrate is coated with an organic water borne coating composition comprising at least one type of Inorganic nano-particles as stain blocking agent. It has been found that by incorporating nano-sized particles into the water borne coating composition comprising an organic polymeric binder, the leaching of water-extractable substances from a substrate into the coating, which becomes visible as stains on the surface of that substrate, is diminished or prevented when the coating composition is applied or during the service life of the coated article. Such water-extractable substances are hereafter called “staining agents”. The inorganic nano-particles can be added to the water borne coating formulation during formulation. Optionally, the inorganic nano-particles are combined with the organic binder to form a stable water borne coating composition.

Preferably, said inorganic nano-particles have an electrical surface charge opposite to that of the staining agents to be blocked. Most preferably, the inorganic nano-particles have a layered structure and a crystal structure with positively charged layers. These inorganic nano particles are particularly effective as stain blocking agents The invention further also relates to a stain blocking water borne coating composition comprising an organic binder and as stain blocking agent at least one type of inorganic nano-particles having a layered structure and a crystal structure with positively charged layers.

It is noted that the term nano-particles refers to nano-sized particles. Nano-sized denotes that at least one linear dimension has a mean size of less than one micron (1 μm=1×10⁻⁶ m), more preferably less than 100 nanometers (1 nm=1×10⁻⁹ m), and most preferably from 0.1 nanometer to about 100 nanometers. There are nano-sized materials with the nano-size in three dimensions, in two dimensions (nano-tubes having a nano-sized cross-section, but an indeterminate length), or in one dimension (nano-layers having a nano-sized thickness, but an indeterminate area). Preferred aspects of the present invention relate to layered materials which comprise nano-layers. The term “layered material” as used throughout the present specification is meant to denote anionic clays, cationic clays, and layered hydroxy salts. It also includes modified forms of these layered materials, such as acid or base leached clays, pillared clays, and thermally treated layered materials that still have a layered structure. As the staining agents generally are of an anionic nature when present in the ionised form, preferably at least one type of nano-particles having a cationic surface charge is employed.

It is noted that the use of zinc hydrotalcite as a UV light stabiliser in coating compositions is described in EP 0 982 356. The zinc hydrotalcite particles are mentioned to have a major diameter of 0.1 to 2 μm, and thickness of 0.01 to 0.3 μm, an aspect ratio of 2 to 200, and a secondary particle diameter of not more than 5 μm. In US 2002/0176982 the use of inorganic nano-particles, such as clay minerals and inorganic metal oxides, in coating compositions for imparting surface modifying benefits for all types of hard surfaces is disclosed. However, said documents do not relate to the problems underlying the present invention and neither disclose nor suggest the use of the nano-particles in accordance with the present invention.

The anionic or cationic clays employed as the Inorganic nano-particles may be used as such or may be exfoliated or intercalated. Intercalated clays consist of a regular insertion of a polymer in between the clay layers. In exfoliated or delaminated clays the individual layers are separated and can be dispersed. The latter configuration is of particular Interest because it maximises the surface area of the layers.

The clays which can be used according to the present invention may be naturally occurring or synthetic. In the method according to the invention, cationic clays can be used. It is however preferred that is anionic clays are used. The inorganic polymeric nano-particles according to the present invention are either added to a water borne coating formulation during formulation, or are first combined with one or more organic polymeric binders forming a stable water borne binder composition, after which a water borne coating composition is prepared.

Anionic Clays

Anionic clays have a crystal structure consisting of positively charged layers built up of specific combinations of divalent and trivalent metal hydroxides between which there are anions and water molecules. Trivalent metals (M³⁺) that can suitably be present in the anionic clay include B³⁺, Al³⁺, Ga³⁺, In³⁺, Bi³⁺, Fe³⁺, Cr³⁺, Co³⁺, Sc³⁺, La³⁺, Ce³⁺, and mixtures thereof. Suitable divalent metals (M²⁺) include Mg²⁺, Ca²⁺, Ba²⁺, Zn²⁺, Mn²⁺, Co²⁺, Mo²⁺, Ni²⁺, Fe²⁺, Sr²⁺, Cu²⁺, and mixtures thereof.

It should be noted that a variety of terms are used to describe the material that is referred to in this specification as an anionic clay. Hydrotalcite-like material and layered double hydroxide (LDH) are interchangeably used by those skilled in the art. In this specification we refer to these materials as anionic clays, comprising within that term hydrotalcite-like and layered double hydroxide materials.

We have now found that anionic clays and, more preferably, layered double hydroxides (LDH) when incorporated into a water borne organic polymeric binder are very effective in the blocking of acidic extractable matter from a variety of substrates. Layered double hydroxides (LDH) have the advantage that they can be incorporated into the polymeric binder without introducing haziness, and hence, clear stain blocking coatings can be produced.

In a particularly preferred embodiment of the present invention, layered double hydroxides of the pyroaurite-sjogrenite-hydrotalcite-group are employed in the coating composition. These LDHs are based upon layers wherein magnesium cations are octahedrally surrounded by hydroxyl groups, which alternate with interstitial layers of water molecules and/or various anions (e.g. carbonate ions). When some of the magnesium in the layer is isomorphously replaced by a higher charged cation, e.g. Al³⁺, then the resulting Mg²⁺—Al³⁺—OH layer gains in positive charge. Hence, an appropriate number of interstitial anions, such as those noted above, is needed to render the overall compound electrically neutral.

Preferred layered double hydroxides of the hydrotalcite-group include but are not limited to hydrotalcite, stichtite, pyroaurite, desautelsite, and sergeevite. Of this group hydrotalcite is most preferred. Hydrotalcite can be described by the formula Mg₄Al₂(OH)₁₂CO₃.H₂O, but these minerals are generally non-stoichiometric by nature and can include some amounts of alternative elements in their compositions.

Hydrotalcites are naturally occurring, but can also be produced synthetically. The methods by which hydrotalcite compounds have been made are found throughout the academic and the patent literature. For example, such methods have been reviewed by Reichle, “Synthesis of Anionic Clay Minerals (Mixed Metal Hydroxides, Hydrotalcite)”, Solid States Ionics, 22 (1986), 135-141, and by Cavani et al., Catalysis Today, Vol. 11, No. 2, (1991). In the case of hydrotalcite-like compounds, the most commonly used production methods involve the use of concentrated solutions of magnesium and aluminium salts, which are often reacted with each other through use reagents such as sodium hydroxide, and various acetates and carbonates. Such chemical reactions produce hydrotalcite, including hydrotalcite-like compounds, which are then filtered, washed, and dried. Alternatively, the hydrotalcite slurry obtained can be incorporated as such into the water borne coating composition. Patent application WO 02/068329 and European patent application EP1204595 describe the synthesis of hydrotalcite involving the use of inexpensive and magnesium sources. The reaction results in the direct formation of an anionic clay that can be obtained by simply drying the slurry retrieved from the reactor. Alternatively, the hydrotalcite slurry obtained in the synthesis can be incorporated as such into the water borne coating composition.

Preferably, the hydrotalcite is modified with one or more dispersing agents in order to stabilise the clay particles. Said dispersing agent may be a low-molecular weight dispersing agent or it may be of an oligomeric or polymeric nature. Sodium hexametaphosphate and sodium polyphosphate are examples of often used low-molecular weight dispersing agents. However, preferably, oligomeric or polymeric dispersants are employed. Most preferably, polymeric surface active materials are used. An example of a commonly used polymeric dispersing agent is sodium polyacrylate. The dispersing agents are normally added in a total amount of around 1%, by weight based on the total weight of solids present in the composition. Non-restrictive examples of types that can be used are marketed under the brand names Solsperse® (Avecia), Hypermer® (Uniqema), or Disperbyk® (BYK-Chemie).

Cationic Clays

Cationic clays differ from anionic clays in that they have a crystal structure consisting of negatively charged layers built up of specific combinations of tetravalent, trivalent, and optionally divalent metal hydroxides between which there are cations and water molecules. Preferred cationic clays include but are not limited to smectites (including montmorillonite, beidellite, nontronite, hectorite, saponite, laponite™, and sauconite), bentonite, illites, micas, glauconite, vermiculites, attapulgite, and sepiolite.

Suitable trivalent metals (M³⁺) for the cationic clay include B³⁺, Al³⁺, Ga³⁺, In³⁺, Bi³⁺, Fe³⁺, Cr³⁺, Co³⁺, Sc³⁺, La³⁺, Ce³⁺, and mixtures thereof. Suitable divalent metals (M²⁺) include Mg²⁺, Ca²⁺, Ba²⁺, Zn²⁺, Mn²⁺, Co²⁺, Mo²⁺, Ni²⁺, Fe²⁺, Sr²⁺, Cu²⁺, and mixtures thereof. Suitable tetravalent metals (M⁴⁺) include Si⁴⁺ and Ti⁴⁺.

The preferred tetravalent metal for the preparation of cationic clays is Si⁴⁺; the preferred trivalent metal is Al³⁺; preferred divalent metals are Mg²⁺, Ca²⁺, and mixtures thereof.

Layered Hydroxy Salts

Layered hydroxy salts (LHS) are distinguished from anionic clays in that they contain only divalent metals or only trivalent metals, whereas anionic clays comprise both a divalent and a trivalent metal. The divalent metal-containing LHS may be considered as an alternating sequence of modified brucite-like layers in which the divalent metal(s) is/are coordinated octrahedrally with hydroxide ions. In one family, structural hydroxyl groups are partially replaced by other anions (e.g. nitrate) that may be exchanged. In another family, vacancies in the octahedral layers are accompanied by tetrahedrically coordinated cations.

An example of an LHS is a hydroxy salt of a divalent metal according to the following idealised formula: [(Me²⁺,M²⁺)₂(OH)₃]⁺(Xⁿ⁻)_{1/n}], wherein Me²⁺ and M²⁺ can be the same or different divalent metal ions and X is an anion. Another example of LHS has the general formula [(Me²⁺,M²⁺)₅₀(OH)₈]²⁺(Xⁿ⁻)_{2/n}], wherein Me²⁺ and M²⁺ can be the same or different divalent metal ions and X is an anion.

If the LHS contains two different metals, the ratio of the relative amounts of the two metals may be close to 1. Alternatively, this ratio may be much higher, meaning that one of the metals predominates over the other. It is important to appreciate that these formulae are ideal and that in practice the overall structure will be maintained although chemical analysis may indicate compositions not satisfying the ideal formula.

Suitable divalent metals (M²⁺ and/or Me²⁺) in the LHS-structure include Mg²⁺, Ca²⁺, Ba²⁺, Zn²⁺, Mn²⁺, Co²⁺, Mo²⁺, Ni²⁺, Fe²⁺, Sr²⁺, Cu²⁺, and mixtures thereof. Another example of LHS is illustrated by [M³⁺(OH)₂]⁺(Xⁿ⁻)_{1/n}, such as La(OH)₂NO₃ wherein the structural cations are now trivalent.

The inorganic nano-particles according to the present invention can be employed in combination with a variety of conventional water borne organic polymeric binders. These binders include polymer dispersions made by means of emulsion polymerisation, such as acrylic and styrene-acrylic dispersions, vinyl acetate copolymers, and the like. These polymer dispersions can be thermoplastic or self-cross-linking. Examples of thermoplastic dispersions are Setalux® 6762 AQ-44 and Setalux® 6763 AQ-42 from Akzo Nobel Resins BV. Examples of self-cross-linking dispersions are Setalux® 6769 AQ-44 and Setalux® 6779 EPL from Akzo Nobel Resins BV. These polymer dispersions can be synthesised using conventional surfactants or by means of a surfactant-free emulsion polymerisation process.

The particles of the polymer dispersion can have a homogeneous or a non-homogeneous morphology. The non-homogeneous morphology may be of the “core-shell” type or it may be a gradient morphology such as described in EP 0 927 198 and US 2001/0034400.

The inorganic nano-particles are preferably used in combination with conventional water borne binders that already have an intrinsic stain blocking nature to further enhance the stain blocking properties. An example of a suitable water borne binder is Setalux® 6773 AQ-44 from Akzo Nobel Resins BV.

Optionally, the polymer dispersion may be obtained by synthesising the polymer in an organic solvent or in bulk. After the synthesis the polymer is emulsified into water.

Cross-linking of the polymer dispersions after applying the coating composition onto the substrate can occur by a variety of conventional mechanisms. Cross-linking in so-called one-component systems can for example be achieved by the carbonyl-hydrazide reaction, by auto-oxidation, or by reaction between activated methylene groups and polyfunctional amines. Cross-linking can also be achieved by the addition of conventional cross-linkers prior to the application of the coating. These methods are often referred to as two-component systems. Commonly used cross-linkers include polyfunctional azidirines such as XAMA-7® from Bayer, carbodiimides, such as Ucarlnk Crosslinker XL-29SE from the Dow Chemical Company, and polyisocyanates. When polyisocyanates are used as cross-linkers, both conventional hydrophobic types such as the biurets or cyclotrimers of hexamethylene diisocyanate or hydrophilically modified types such as Bayhydur® 3100 from Bayer can be employed. Optionally, blends of hydrophobic and hydrophilic polyisocyanates may be used.

Examples of binders that can be cross-linked using polyisocyanates are Setalux® 6511 AQ47 and Setalux® 6520 AQ-45. Examples of binders that can be cross-linked by the addition of carbodiimides or polyaziridines include virtually all water borne binders having carboxylic acid functionality.

Another class of water borne binders that is suitable for use in the stain blocking water borne coating composition according to the present invention is formed by conventional alkyd emulsions. Alkyd emulsions are generally produced by preparing an alkyd binder by conventional polycondensation methods and emulsifying said binder in water afterwards. The hydrophilic groups needed to stabilise the alkyd particles in the aqueous phase can be ionic or non-ionic and can be introduced by the use of conventional surfactants or by modifying the alkyd during or after the synthesis with stabilising groups. An example of such a polymer is Uradil® AZ 554 Z-50, an alkyd dispersion ex DSM Coating Resins, or Dynotal® LS82 ex Dyno ASA. Optionally, the alkyd emulsions are modified with di- or polyisocyanates prior to or after the emulsification. Alkyd emulsions thus modified have the advantage of drying faster than non-isocyanate-modified alkyd emulsions. Examples of such products are Setal® 6002 AQ-45 and Setal® 6003 AQ-40 ex Akzo Nobel Resins.

Other types of auto-oxidisable polymers are acrylic-modified alkyd dispersions such as Resydrol® AY 586w ex UCB Surface Specialities. Also Bayhydrol® B130, a water reducible, oxidatively drying styrene-butadiene resin available from Bayer can be used.

A further class of water borne binders suitable for use in the stain blocking water borne coating composition according to the present invention is formed by conventional polyurethane dispersions. Polyurethane dispersions can be made by a variety of methods using a wide range of raw materials. Examples of aliphatic polyester based polyurethane dispersions are NeoRez® R-974 ex NeoResins and Alberdingk U 320 ex Alberdingk Boley.

Also the use of conventional water borne hybrids between urethane and acrylic polymers as binders is included in the scope of this invention. An example of such an acrylic-urethane copolymer is NeoPac® E-125 ex NeoResins.

Furthermore, the binder which can be used in accordance with the present invention may comprise conventional UV-curable water borne polymer dispersions. Examples of suitable UV-curable water borne polymer dispersions are acryloyl-functional urethane dispersions such as Bayhydrol® UV LS 2280 ex Bayer or NeoRad® R440 ex NeoResins. Also UV curable aqueous acrylic dispersions such as Lux® 352 ex Alberdingk Boley or Primal® E-3120 ex Rohm and Haas can be used.

Instead of using only one water borne organic polymeric binder in the water borne coating composition according to the present invention, a combination of several of the polymer dispersions mentioned above can be used. Also conventional additives can be added to the water borne coating composition, such as coalescing solvents, defoamers, neutralising bases, etc. When reference is made to the water borne coating composition according to the present invention, all of these additives, including the water, are included.

A stain blocking water borne coating composition can be prepared using the water borne coating composition according to the invention. The coating composition may be a clear or a pigmented coating composition. In a preferred embodiment of the invention, the coating composition is a clear coating composition. For the clear coating composition, the nano-particles preferably are layered double hydroxides (LDH), preferably hydrotalcite nano-particles, which result in an excellent clear coating with high gloss and little or no haziness. With

The coating composition may be used as an impregnating layer, a primer, or a top coat. In addition to the water borne coating composition, the coating composition may contain conventional components, such as emulsifiers, pigments and fillers, dispersants, coalescing agents, curing agents, thickeners, humectants, wetting agents, biocides, plasticisers, antifoaming agents, colourants, waxes, and antioxidants. The water borne coating composition preferably comprises a dispersion agent to stabilise the composition. The amount of dispersion agent depends on the type of coating composition. For anionic clay or layered double hydroxides, it was found that stable compositions can be obtained at an amount of dispersion agent of at least 0.15 wt percent, more preferably at least 0.3 and most preferably at least 0.5 wt percent relative to the total weight of the coating composition.

The total amount of inorganic nano-particles in the water borne coating composition according to the present invention preferably is at least 0.1% by weight, more preferably at least 0.5% by weight, and most preferably at least 1.0% by weight, based on the total weight of the water borne coating composition. The total amount of inorganic nano-particles in the water borne coating composition preferably is at most 40% by weight, more preferably at most 35% by weight, and most preferably at most 25% by weight, based on the total weight of the water borne coating composition. The amount of inorganic nano particles is preferably between 0.1 and 50, more preferably between 0.2 and 20 and most preferably between 0.3 and 15 weight percent relative to the total solids content of binder and optional crosslinker in the coating composition.

The amount of the one or more water borne organic polymeric binders in the water borne coating composition can vary between wide ranges, depending on the type of binder used. Preferably, the amount is at least 4% by weight, more preferably at least 10% by weight, and most preferably at least 20% by weight, based on the total weight of the water borne coating composition. The amount of water borne organic polymeric binders in the coating composition preferably is at most 80% by weight, more preferably at most 70% by weight, and most preferably at most 60% by weight, based on the total weight of the water borne coating composition. For polyacrylate binder systems, the amount of binder is typically between 30 and 60 weight percent.

The coating compositions according to the invention can be applied to a substrate in any manner desired, e.g., by means of rolling, spraying, brushing, sprinkling, doctor blade application, flow coating, dipping, air-atomised spraying, air-assisted spraying, airless spraying, high volume low pressure spraying, air-assisted airless spraying, and electrostatic spraying, printing, or coating by electrophoresis. Curing can be carried out at ambient temperature or, optionally, at an elevated temperature to reduce the curing time. If so desired, the composition may be baked at higher temperatures, e.g. of between 60 and 160° C., in a drying oven for 10 to 60 minutes.

The substrates which are suitable for coating with the stain blocking water borne coating composition according to the invention are wooden substrates such as Pine, Fir, Hemlock, Spruce, Oak, Ash, Mahogany, Cedar (all types), Pine, Merbau, Teak, Oregon, Cypress, Meranti, Lauan, Rosewood, Black Bean, Iroco, Lark (all types), Balsa, Kauri, Walnut, Blackwood, Myrtle, and Sassafras, or substrates made from processed wood such as hard board, medium density fibre board, chipboard, or paper laminates. Other suitable substrates include but are not limited to mineral substrates, such as masonry, cement, fibre cement, cement asbestos, plaster, plasterboard, glazed and unglazed ceramic; metal, such as gaivanised iron, galvanised steel, cold rolled steel, stainless steel, zinc alloys, and aluminium; previously painted or primed surfaces (fresh, aged or weathered), such as acrylic coatings, vinyl copolymer coatings, styrene acrylic coatings, powder coated surfaces, solvent borne acrylic coatings, alkyd resin coatings, solvent urethane coatings, and epoxy coatings; and synthetic substrates, such as polyvinyl chloride, polyethylene, and polypropylene, which carry markings deposited by aqueous or non-aqueous compositions such as those from marking pens or which contain water-soluble chromophoric staining compounds such as tannins, where such stains are capable of appearing, to a greater or lesser extent, on the surface of a dry later-deposited coating, or which contain salts which can cause efflorescence.

The present invention is elucidated by means of the following non-limiting Examples. Table IV lists the compounds used in the examples with indication of trade name, the producing company and the function of the compound in the coating compositions.

### EXAMPLE 1

### Water Borne Coating Containing Inorganic Nano-Particles

A water borne primer was prepared by blending 67.7 parts of Setalux® 6769 AQ-44 (ex Akzo Nobel Resins) with 5.6 parts of Dowanol® PM (ex Dow Chemicals), 0.3 parts of Dehydran® 1293 (ex Cognis), 0.3 parts of Byk® 333 (ex Byk-Chemie), 0.3 parts of Proxel® XL 2 (ex Avecia), and 1 part of Nuvis FX in 1010 (10% solution in water ex Condea Servo).

To this mixture, 19.3 parts of an aqueous hydrotalcite slurry made according to Patent Application EP 1204595 at a solids content of 2.5% were carefully added under stirring.

### COMPARATIVE EXAMPLES 2 AND 4 AND EXAMPLE 3

Comparative Examples 2 and 4 and Example 3 were prepared as described in Example 1 using the ingredients from Table I.

TABLE I
Primer compositions

| Ingredients | Comp. Ex. 2 | Ex. 3 | Comp. Ex. 4 |
|---|---|---|---|
| Setalux ® 6769 AQ-44 | 85.00 | | |
| Setalux ® 6773 AQ-44 | | 70.00 | 63.8 |
| Setalux ® 6771 AQ-44 | | | 27.3 |
| Dowanol ® DPM | 6.60 | | |
| Texanol ® ⁽¹⁾ | | 2.60 | 5.2 |
| Tegofoamex ® 805 ⁽²⁾ | | 0.30 | 0.2 |
| Dehydran ® 1293 ⁽³⁾ | 0.30 | | |
| Byk ® 333 ⁽⁴⁾ | 0.30 | 0.30 | |
| Proxel ® XL2 | 0.30 | 0.30 | 0.2 |
| Primal ® RM8 (25% sol in | | | 0.5 |
| demineralised water) ⁽⁵⁾ | | | |
| Nuvis ® FX1010 (10% | 1.00 | 1.00 | |
| aqueous solution) | | | |
| Aquacer ® 490A | | | 2.8 |
| Hydrotalcite slurry ⁽⁵⁾ | | 19.30 | |
| Demineralised water | 6.50 | 6.20 | |
| Total | 100.00 | 100.00 | 100.0 |

(⁽¹⁾ ex Eastman Chemicals,
⁽²⁾ ex Degussa,
⁽³⁾ ex Rohm and Haas,
⁽⁴⁾ ex Byk-Chemie,
⁽⁵⁾ made according to patent application EP 1204595 at a solids content of 2.5%)

The primers prepared following the procedures of Examples 1-4 were applied in two or three layers onto Merbau and Redwood test-panels. The first layer of the 10 primer was applied with a yield between 7 and 9 m²/litre and the second primer layer was applied with a yield between 14 and 20 m²/litre. The drying time in between application of the first and second layers was approximately 6-8 hours. After the application of the primer layers, no bleeding of tannins could be observed. The primer was subsequently over-coated with a clear coat obtained by mixing the Ingredients In Table II or a top coat obtained as described below using the ingredients mentioned in Table III. The top coat layer was applied after 16-24 hrs of drying and with a yield between 9 and 13 m²/litre, For the clear coat equal drying times were used and said coat was applied with a yield between 7 and 10 m²/litre.

TABLE II
Clear-coat composition

| | |
|---|---|
| Setalux ® 6769 AQ-44 | 85 |
| Dowanol ® DPM | 6.6 |
| Dehydran ® 1293 | 0.3 |
| Byk ® 333 | 0.3 |
| Proxel ® XL2 | 0.3 |
| Nuvis ® FX1010 (10% aqueous solution) | 1 |
| Demineralised water | 6.5 |

TABLE III
Pigmented topcoat composition.

| Mill base: | |
|---|---|
| Demineralised water | 35.4 |
| Propylene glycol | 29.9 |
| Orotan ® 1124 ⁽¹⁾ | 1.5 |
| Ammonia 25% | 2.0 |
| Proxel ® XL2 | 0.5 |
| Foamaster ® 111 ⁽²⁾ | 1.0 |
| Kronos ® 2190 ⁽³⁾ | 199.7 |

(⁽¹⁾ ex Rohm and Haas,
⁽²⁾ ex Cognis,
⁽³⁾ ex Kronos)

| Paint preparation: | |
|---|---|
| Setalux ® 6769 AQ-44 | 608.8 |
| Berol ® 09 ⁽¹⁾ (25% in demineralised water) | 22.0 |
| Mill base | 270.0 |
| Dehydran ® 1293 | 2.0 |
| Dowanol ® DPnB ⁽²⁾ | 16.0 |
| Demineralised water | 30.0 |

(⁽¹⁾ ex Akzo Nobel Surface Chemistry,
⁽²⁾ ex Dow Chemicals)

The mill-base was dispersed on a horizontal pearl mill and added to the mixture of Setalux® 6769 AQ-44 and Berol® 09. After the addition of the mill-base the other ingredients were added while stirring. Finally, the viscosity of the paint was adjusted by adding a thickener solution consisting of 25.6 parts of demineralised water, 3.2 parts of ammonia (25% strength), and 22.4 parts of Acrysol® RM 5 (ex Rohm and Haas),

The substrates were dried for one week at 23° C. and afterwards exposed in the humidity cabinet for 1 week at 40° C. and a relative humidity of 100%. The tannin bleeding was observed visually and rated from 0 (no bleeding) to 5 (severe bleeding). The results are given in Table IV.

TABLE IV
Results after one week at 40° C. and 100% relative humidity

| | | | Comp. | | Comp. |
|---|---|---|---|---|---|
| Substrate | Paint system | Ex. 1 | Ex. 2 | Ex. 3 | Ex. 4 |
| Merbau | Primer (3×) | 0 | 0 | 3 | 5 |
| Merbau | Primer (2×), | 0 | 0 | 3 | 5 |
| | clear coat (1×) | | | | |
| Merbau | Primer (2×), | 1 | 1 | 1 | 5 |
| | top coat (1×) | | | | |
| Red cedar | Primer (3×) | 0 | 0 | 0 | 5 |
| Red cedar | Primer (2×), | 0 | 1 | 0 | 5 |
| | clear coat (1×) | | | | |
| Red cedar | Primer (2×), | 0 | 0 | 0 | 5 |
| | top coat (1×) | | | | |

From this table it can be seen that the hydrotalcite modification offers distinct advantages compared to the primers from the comparative examples.

### EXAMPLE 5

### Water Borne Coating Composition Containing Nano-Particles

To 50 grams of a hydrotalcite slurry with a solids content of 5.5% made according to Patent Application EP 1204595 3.5 grams of Solsperse 41090 (ex Avecia) were added under stirring. Subsequently, the mixture was neutralised with dimethyl ethanolamine (DMEA), i.e. 100 parts of Solsperse 41090 were combined with 4.5 parts of DMEA. 15 grams of the mixture thus obtained were added to Setalux 6779EPL, a binder commercially available from Akzo Nobel Resins BV, under stirring. This resulted in a stable, nano-particle-containing water borne coating composition with a solids content of 33%.

When applied to a glass plate with a doctor blade and dried at ambient temperature, a glossy transparent film was obtained.

### EXAMPLES 6-12

Additional water borne coating compositions were made according to the procedure of Example 5 using the ingredients mentioned in Table V. The stability of the water borne binders was checked after storage at 40° C. for 4 weeks. Sedimentation in the binders was assessed and their stability was ranked on a scale of 0 (no sedimentation) to 5 (severe sedimentation).

TABLE V
Water borne coating compositions.

| Compo- | | | | | | | | |
|---|---|---|---|---|---|---|---|---|
| nent | Ex. 5 | Ex. 6 | Ex. 7 | Ex. 8 | Ex. 9 | Ex. 10 | Ex. 11 | Ex. 12 |
| Hydro- | 13.95 | 14.1 | 14.25 | 14.4 | 14.55 | 14.7 | 14.85 | 15 |
| talcite | | | | | | | | |
| slurry * | | | | | | | | |
| Sol- | 1.05 | 0.9 | 0.75 | 0.6 | 0.45 | 0.3 | 0.15 | 0 |
| sperse | | | | | | | | |
| 41090 | | | | | | | | |
| Setalux | 35 | 35 | 35 | 35 | 35 | 35 | 35 | 35 |
| 6779 | | | | | | | | |
| EPL | | | | | | | | |
| Stabil- | 1 | 1 | 2 | 2 | 1 | 3 | 3 | 5 |
| ity | | | | | | | | |

(* made according to Patent Application EP 1204595 at a solids content of 2.5%)

From this table it can be seen that when the hydrotalcite is modified with a dispersing agent, thus stabilising the clay particles, improved results are obtained.

### EXAMPLE 13

### Water Borne Coating Composition

A water borne primer was prepared by blending 87 parts of the water borne coating composition from Example 5 with 5.6 parts of Dowanol® DPM (ex Dow Chemicals), 0.3 parts of Dehydran® 1293 (ex Cognis), 0.3 parts of Byk® 333 (ex Byk-Chemie), 0.3 parts of Proxel® XL 2 (ex Avecia), 5.5 parts of demineralised water, and I part of Nuvis FX 1010 (10% active material as a solution of 20 parts Serad® FX 1010 and 60 parts of water and 20 parts of butylglycol) (ex Condea Servo).

Two layers of this primer were applied by brush to Merbau and Western red cedar (first layer 1.2-1.4 g/0.01 m², second layer 0.5-0.6 g/0.01 m²). No bleeding was observed upon application of the primer layers, nor when the pigmented or clear top coats were applied as described in Examples 1-4.

TABLE VI

| Ingredients | From company | Product description | function |
|---|---|---|---|
| Dowanol ® PM | Dow Chemicals | Propylene Glycol Methyl Ether | Coalescing solvent |
| Setalux ® 6769 AQ-44 | Nuplex Resins | Acrylic dispersion from Nuplex Resins BV | Binder |
| Setalux ® 6773 AQ-44 | Nuplex Resins | Acrylic dispersion from Nuplex Resins BV | Binder |
| Setalux ® 6771 AQ-44 | Nuplex Resins | Acrylic dispersion from Nuplex Resins BV | Binder |
| Dowanol ® DPM | Dow Chemicals | Dipropylene Glycol Methyl Ether | Coalescing solvent |
| Texanol ® | Eastman | Isobutyric acid, ester with 2,2,4-trimethyl-1,3- | Coalescing solvent |
| | Chemicals | pentanediol | |
| Tegofoamex ® 805 | ex Degussa, | emulsion of a polyether siloxane copolymer, silica- | Anti-foaming agent |
| | | free | |
| Dehydran ® 1293 | Cognis | Polysiloxane copolymer defoamer for aqueous | Anti-foaming agent |
| | | paints | |
| Byk ® 333 | Byk-Chemie | Polyether modified polydimethylsiloxane | surface additive |
| Proxel ® XL2 | Avecia | 1,2-Benzisothiazol-3(2H)-one | biocide |
| Primal ® RM8 (25% sol in | Rohm and Haas | Polyurethane thickener (HEUR) | Thickener solution |
| demineralised water) | | | |
| Nuvis ® FX1010 (10% | Condea Servo | polyurethane thickener | Thickener solution |
| aqueous solution) | | | |
| Aquacer ® 490A ⁽⁴⁾ | Byk-Chemie | Non ionic aqueous emulsion based on a paraffin | wax |
| | | wax | |
| Hydrotalcite slurry ⁽⁵⁾ | Akzo Nobel | Slurry of hydrotalcite clay particles | Stain blocking agent |
| | Chemicals | | |
| Orotan ® 1124 ⁽¹⁾ | Rohm and Haas | Hydrophilic copolymer | dispersant |
| Foamaster ® 111 | Cognis | Silicone free broad spectrum, non-phase | Anti-foaming agent |
| | | separating defoamer. | |
| Kronos ® 2190 | Kronos | Titanion dioxide | pigment |
| Berol ® 09 | Akzo Nobel | Nonyl phenol ether | surfacatant |
| | Surface | | |
| | Chemistry | | |
| Mill base | | | |
| Dowanol ® DPnB | Dow Chemicals | Dipropylene Glycol n-Butyl Ether | Coalescing solvent |
| Acrysol ® RM 5 | Rohm and Haas | Hydrophobic modified acrylic thickener | thickener |
| Solsperse 41090 | Avecia | 90% active polymeric dispersant in water | dispersant |
| Setalux 6779EPL | Nuplex Resins BV | Acrylic dispersion from Nuplex Resins BV | binder |
| Serad ® FX 1010 | Condea Servo | Proprietary polymer | Thickening agent |

⁽⁵⁾ made according to patent application EP 1204595 at a solids content of 2.5%)

1. A stain blocking water borne coating composition comprising an organic binder and as stain blocking agent at least one type of inorganic nano-particles having a layered structure and a crystal structure with positively charged layers.

2. The stain blocking water borne coating composition according to claim 1, wherein the nano-particles are anionic clays or layered double hydroxide (LDH) salts.

3. The stain blocking water borne coating composition according to claim 2, wherein the layered double hydroxide (LDH) is selected from the group consisting of hydrotalcite, stichtite, pyroaurite, desautelsite.

4. The stain blocking water borne coating composition according to claim 1, comprising one or more water borne organic polymeric binders selected from the group consisting of acrylic and styrene-acrylic dispersions, vinyl acetate copolymer dispersions, alkyd emulsions, polyurethane dispersions, water borne hybrids between urethane and acrylic polymeric dispersions, and UV-curable water borne polymer dispersions.

5. The stain blocking water borne coating composition according to claim 1, further comprising one or more components selected from the group consisting of emulsifiers, pigments, fillers, dispersants, coalescing agents, curing agents, thickeners, humectants, wetting agents, biocides, plasticisers, antifoaming agents, colourants, waxes, and antioxidants.

6. The stain blocking water borne coating composition according to claim 1, which composition is a clear coat composition.

7. The stain blocking water borne coating composition according to claim 1, further comprising at least 0.3 wt percent of a dispersing agent.

8. The stain blocking water borne coating composition according to claim 1, wherein the total amount of inorganic nano-particles is 0.140% by weight, based on the total weight of the water borne coating composition, and wherein the total amount of organic binder is 4-80% by weight, based on the total weight of the water borne coating composition.

9. (canceled)

10. A method for coating a substrate comprising water extractable staining agents wherein the substrate is coated with an organic water borne coating composition comprising at least one type of inorganic nano-particles as stain blocking agent.

11. The method according to claim 10, wherein the inorganic nano-particles comprise anionic clays, cationic clays and/or layered hydroxy salts (LHS).

12. The method according to claim 10, wherein substrate is coated with the stain blocking water borne coating composition according to claim 1.

13. A coated substrate comprising water extractable staining agents obtainable by the method according to claim 10.

14. The coated substrate according to claim 13, wherein the substrate is selected from the group consisting of a wooden, cementitous, metal, mineral and synthetic substrate, substrate made from processed wood, painted wood or primed wood.

15. Use of one or more types of inorganic nano-particles as stain blocking agent in an organic water borne coating composition.

16. Use according to claim 15, wherein the inorganic nano-particles comprise anionic clays, cationic clays and/or layered hydroxy salts (LHS).

17. Use according to claim 16, wherein the inorganic nano-particles comprise a layered double hydroxide (LDH).

18. Use according to claim 17, wherein the layered double hydroxide (LDH) is selected from the group consisting of hydrotalcite, stichtite, pyroaurite, desautelsite, and sergeevite.

19. The stain blocking water borne coating composition according to claim 3, wherein the layered double hydroxide (LDH) is optionally modified with one or more dispersing agents.

20. The coated substrate according to claim 14, wherein said substrate is a tannin-containing wooden substrate.

21. The stain blocking water borne coating composition according to claim 18, wherein the layered double hydroxide (LDH) is optionally modified with one or more dispersing agents.
